(19) United States
(12) Patent Application Publication
(10) Pub. No.: US 2012/0289659 A1
(43) Pub. Date: Nov. 15, 2012

(54) CROSS-LINKING RESIN COMPOSITION AND MIXTURE

(75) Inventor: Takeshi Iizuka, Tokyo (JP)

(73) Assignee: Olympus Corporation, Tokyo (JP)

(21) Appl. No.: 13/468,324

(22) Filed: May 10, 2012

(30) Foreign Application Priority Data
May 12, 2011 (JP) 2011-107560

(51) Int. Cl. C08L 9/00

(52) U.S. Cl. 525/193

(57) ABSTRACT

This cross-linking resin composition containing polyethylene, polybutadiene and a Co-cross-linking agent containing a polyfunctional monomer having double bonds between carbons at two positions or more, and wherein the polyethylene, the polybutadiene and the cross-linking auxiliary agent are mixed and formed by being molded in a predetermined form, and wherein the cross-linking resin composition having a cross-linked region that is subjected to cross-linking reaction by ionizing radiation and a non-cross-linked region that is not subjected to the cross-linking reaction.

### BACKGROUND OF THE INVENTION

1. Field of the Invention

The present invention relates to a cross-linking resin composition, and more specifically to a cross-linking resin composition in which an elastic modulus is partially improved by cross-linking reaction and a mixture which can be used as a material of the cross-linking resin composition.

Priority is claimed on Japanese Patent Application No. 2011-107560, filed May 12, 2011, the contents of which is incorporated herein by reference.

2. Description of Related Art

In the related art, a technique of improving an elastic modulus by performing cross-linking reaction on a resin material is known. For example, by performing cross-linking reaction on an epoxy resin, a resin with a high viscosity is changed to a resin with a high elastic modulus. Furthermore, elastic moduli of a silicone resin or the like are also changed before and after performing cross-linking reaction.

In addition, Japanese Unexamined Patent Application, First Publication No. 2006-089759 discloses a resin material in which polyethylene and polybutadiene are mixed.

In recent years, focusing on the above-described phenomenon, it has been discussed to produce a resin composition having portions with high and low elastic moduli is produced by performing cross-linking reaction only on a portion of a resin material and to make use of the resin composition in various fields. In this case, the larger the difference between elastic moduli of a cross-linked region which is subjected to cross-linking reaction and a non-cross-linked region which is not subjected to cross-linking reaction is, the more easily produced a composition suitable for various applications and purposes is, which is preferable.

### SUMMARY OF THE INVENTION

According to a first aspect of the present invention, a cross-linking resin composition containing polyethylene, polybutadiene and a Co-cross-linking agent containing a polyfunctional monomer having double bonds between carbons at two positions or more, and wherein the polyethylene, the polybutadiene and the cross-linking auxiliary agent are mixed and formed by being molded in a predetermined form, and wherein the cross-linking resin composition having a cross-linked region that is subjected to cross-linking reaction by ionizing radiation; and a non-cross-linked region that is not subjected to the cross-linking reaction.

According to a second aspect of the present invention, in the cross-linking resin composition of the first aspect of the present invention, an elastic modulus of the cross-linked region is more than or equal to twice that of the non-cross-linked region.

According to a third aspect of the present invention, in the cross-linking resin composition of the first aspect of the present invention, the elastic modulus of the non-cross-linked region is more than or equal to 100 MPa and less than or equal to 1000 MPa.

According to a fourth aspect of the present invention, in the cross-linking resin composition of the second aspect of the present invention, the elastic modulus of the non-cross-linked region is more than or equal to 100 MPa and less than or equal to 1000 MPa.

According to a fifth aspect of the present invention, a mixture which is formed by mixing polyethylene, polybutadiene, and a Co-cross-linking agent configured to contain a polyfunctional monomer having double bonds between carbons at two positions or more, wherein an elastic modulus of the mixture after being subjected to cross-linking reaction by ionizing radiation is more than or equal to twice that before the cross-linking reaction.

According to a sixth aspect of the present invention, in the mixture of the fifth aspect of the present invention, wherein the elastic modulus before the cross-linking reaction is more than or equal to 100 MPa and less than or equal to 1000 MPa.

### BRIEF DESCRIPTION OF THE DRAWINGS

FIG. 1 is a schematic diagram illustrating a medical tube according to an embodiment of a cross-linking resin composition of the present invention.

FIG. 2 is a diagram illustrating an endotherapeutic device equipped with the medical tube according to the embodiment of the cross-linking resin composition of the present invention, as a sheath.

### DETAILED DESCRIPTION OF THE INVENTION

An embodiment of the present invention will be described below.

A cross-linking resin composition according to this embodiment is formed by mixing polyethylene, polybutadiene and a Co-cross-linking agent, molding a mixture in a desired form, and performing cross-linking reaction using ionizing radiation on a portion of a material.

As the polyethylene, various types of well-known polyethylene such as low-density polyethylene (LDPE), high-density polyethylene (HDPE), or linear low-density polyethylene (LLDPE) can be used.

The cross-linking auxiliary agent is not particularly limited as long as it contains a polyfunctional monomer having double bonds between carbons at two positions or more. In addition, the cross-linking auxiliary agent may contain a plurality of polyfunctional monomers. For example, triallyl isocyanurate (TAIC), triallyl cyanurate, trimethallyl isocyanurate (TMAIC), and trimethylolpropane triacrylate or the like can be used.

When the cross-linking resin composition according to the present embodiment is produced, a mixture in which polyethylene, polybutadiene, and the cross-linking auxiliary agent are melted and mixed is prepared first. This mixture is molded in a predetermined form to obtain a molding material. As amounts of the materials, 5 parts by weight to 10 parts by weight of cross-linking auxiliary agent are mixed with 20 parts by weight to 70 parts by weight of polyethylene, 80 parts by weight to 30 parts by weight of polybutadiene.

Next, a portion of the molding material is irradiated with ionizing radiation to form a cross-linked region. Examples of the usable ionizing radiation include electron beams, accelerated electron beams, γ-rays, X-rays, α-rays, β-rays, and ultraviolet rays. Among these, the accelerated electron beams and the γ-rays are preferably used from the viewpoints of industrial applications such as simple radiation source, transmission thickness of ionizing radiation, or rate of cross-linking reaction. A voltage of the accelerated electron beams can be appropriately selected according to a thickness of the molding material. An exposure of the ionizing radiation may be selected to be, for example, in the case of the electron beams, 100 kGy to 500 kGy and preferably 200 kGy to 400 kGy. In general, as the exposure of irradiation is greater, a cross-linking region is harder, resulting in the increase of an elastic modulus. When the cross-linking resin composition under the premise that it will be bent in an environment of usage is produced, an elastic modulus after cross-linking is made to be less than or equal to 1000 MPa and thus preferable physical properties can be imparted.

When a cross-linked region is formed in a portion of the molding material, a region in the molding material where the cross-linking reaction is not performed is covered with, for example, a shield formed of lead or the like. Thereafter, the molding material is irradiated with ionizing radiation. Accordingly, a region irradiated with the ionizing radiation becomes the cross-linked region and a region covered with the shield becomes a non-cross-linked region on which cross-linking is not performed. The non-cross-linked region maintains a property of a thermoplastic resin as a material. Therefore, by appropriately setting a position or range of the region covered with the shield, the cross-linked region can be formed in a desired position and range of the molding material.

When the cross-linking reaction is finished, the region not subjected to the cross-linking reaction remains as the non-cross-linked region. In the region subjected to the cross-linking reaction of the molding material, an elastic modulus improves more than or equal to twice that of the non-cross-linked region. As a result, the cross-linking resin composition in which the elastic moduli between the cross-linked region and the non-cross-linked region are largely different can be produced. In a resin composition having a cross-linked region and a non-cross-linked region of the related art, it is significantly difficult to produce a resin composition in which an elastic modulus of the cross-linked region is more than or equal to twice that of the non-cross-linked region. This point will be described below in detail using an example.

The cross-linking resin composition according to this embodiment can be produced as various kinds of structures by processing it in a predetermined form. A process of molding in a form of a structure may be performed when the molding material is obtained. In this case, when the cross-linking reaction is finished, the structure is completed.

To the cross-linking resin composition according to this embodiment, in a range that will not interfere with the application and purpose, hydrolysis inhibitors, processing stabilizers, inorganic fillers, colorants such as carbon black, nucleating agents, oxidative degradation inhibitors, ultraviolet absorbers, antistats, lubricants, plasticizers, flame retardants and the like may be optionally added.

Next, production procedures and elastic moduli before and after cross-linking of molding materials having various compositions will be described. Hereinafter, it will be described with a material which can be used as a cross-linking component of this embodiment is named “Exemplary Material”, and a material which cannot be used as a cross-linking component of this embodiment is named “Comparative Material”.

### Exemplary Material 1

10 parts by weight of TMAIC as the cross-linking auxiliary agent was applied to 70 parts by weight of LDPE having an elastic modulus of 150 MPa and 30 parts by weight of polybutadiene. A mixture obtained by melting and mixing these was processed to have a sheet form with a size of 100 mm by 100 mm and a thickness of 2 mm to obtain a molding material.

### Exemplary Material 2

10 parts by weight of TAIC as the cross-linking auxiliary agent was applied to 20 parts by weight of the same LDPE as that of Exemplary Material 1 and 80 parts by weight of polybutadiene. A mixture obtained by melting and mixing these was processed in the same way as in Exemplary Material 1 to obtain a molding material.

### Exemplary Material 3

10 parts by weight of TMAIC as the cross-linking auxiliary agent was applied to 20 parts by weight of the same LDPE as that of Exemplary Material 1 and 80 parts by weight of polybutadiene. A mixture obtained by melting and mixing these was processed in the same way as in Exemplary Material 1 to obtain a molding material.

### Exemplary Material 4

5 parts by weight of TAIC as the cross-linking auxiliary agent was applied to 20 parts by weight of the same LDPE as that of Exemplary Material 1 and 80 parts by weight of polybutadiene. A mixture obtained by melting and mixing these was processed in the same way as in Exemplary Material 1 to obtain a molding material.

### Comparative Material 1

70 parts by weight of the same LDPE as that of Exemplary Material 1 and 30 parts by weight of polybutadiene were meltied and mixed without adding the cross-linking auxiliary agent to prepare a mixture. This mixture was processed in the same way as in Exemplary Material 1 to obtain a molding material.

### Comparative Material 2

10 parts by weight of TAIC as the cross-linking auxiliary agent was applied to 70 parts by weight of the same LDPE as that of Exemplary Material 1 and 30 parts by weight of polybutadiene. A mixture obtained by melting and mixing these was processed in the same way as in Exemplary Material 1 to obtain a molding material.

### Comparative Material 3

10 parts by weight of TAIC as the cross-linking auxiliary agent was applied to 100 parts by weight of the same LDPE as that of Exemplary Material 1 without mixing with polybutadiene. A mixture obtained by melting and mixing these was processed in the same way as in Exemplary Material 1 to obtain a molding material.

### Comparative Material 4

5 parts by weight of TAIC as the cross-linking auxiliary agent was applied to 100 parts by weight of polybutadiene without mixing with LDPE. A mixture obtained by melting and mixing these was processed in the same way as in Exemplary Material 1 to obtain a molding material.

Using each of the materials obtained as a specimen, a bending elastic modulus was measured according to JIS K 7171 to obtain an elastic modulus value before cross-linking reaction, that is, the value of a non-cross-linked region. Thereafter, each of the materials was irradiated with a predetermined electron beam dose to perform cross-linking reaction. Then, a bending elastic modulus was measured again to obtain an elastic modulus value after cross-linking reaction, that is, the value of a cross-linked region.

The results thereof are shown in Table 1. Table 1 also shows the electron beam dose which irradiated each of the materials.

TABLE 1

| | Exemplary | Exemplary | Exemplary | Exemplary | Comparative | Comparative | Comparative | Comparative |
|---|---|---|---|---|---|---|---|---|
| | Material 1 | Material 2 | Material 3 | Material 4 | Material 1 | Material 2 | Material 3 | Material 4 |
| Polyethylene (LDPE) | 70 | 20 | 20 | 20 | 70 | 70 | 100 | |
| Polybutadiene | 30 | 80 | 80 | 80 | 30 | 30 | | 100 |
| Trimethallyl isocyanurate | 10 | | 10 | | | | | |
| (TMAIC) | | | | | | | | |
| Triallyl isocyanurate (TAIC) | | 10 | | 5 | | 10 | 10 | 5 |
| Amounts of radiation | 300 | 400 | 400 | 200 | 400 | 0 | 400 | 200 |
| exposures (kGy) | | | | | | | | |
| Elastic modulus before | 120 | 100 | 100 | 100 | 110 | 110 | 150 | 30 |
| cross-linking (MPa) | | | | | | | | |
| Elastic modulus after | 290 | 370 | 260 | 220 | 130 | 110 | 170 | 70 |
| cross-linking (MPa) | | | | | | | | |
| Ratio of elastic moduli | 2.4 | 3.7 | 2.6 | 2.2 | 1.2 | 1.0 | 1.1 | 2.3 |
| (after cross-linking/before | | | | | | | | |
| cross-linking) | | | | | | | | |

As shown in Table 1, in Comparative Material 1 and Comparative Material 2, values of elastic moduli after cross-linking reaction were less than 1.5 times those values of elastic moduli before cross-linking reaction, and the cross-linking reactions were not able to significantly improve the elastic moduli. In addition, in Comparative Material 4, an elastic modulus after cross-linking reaction was more than or equal to twice that before cross-linking. However, in Comparative Material 4, absolute values of the elastic moduli fell below 100 MPa, irrespective of cross-linking reaction. In particular, the elastic modulus of Comparative Material 4 before cross-linking was 30 MPa, which is an insufficient value for producing a structure which maintains a certain form.

On the other hand, in Exemplary Materials 1 to 4, all of the elastic moduli after cross-linking reaction were more than twice those before cross-linking reaction. Specifically, in Exemplary Materials 1 to 4, the above-described elastic moduli were changed in the range from 2.2 times to 3.7 times. In addition, in all of the Exemplary Materials, the elastic moduli before cross-linking reaction were more than or equal to 100 MPa.

As described above, in Exemplary Materials, it has been shown that the cross-linking reaction can significantly improve an elastic modulus and a cross-linking resin composition which maintains a predetermined form can be produced even when a non-cross-linked region remains. In addition, when an exposure of irradiation is increased in the cross-linking reaction, the value of the elastic modulus after the cross-linking reaction shows a tendency to increase.

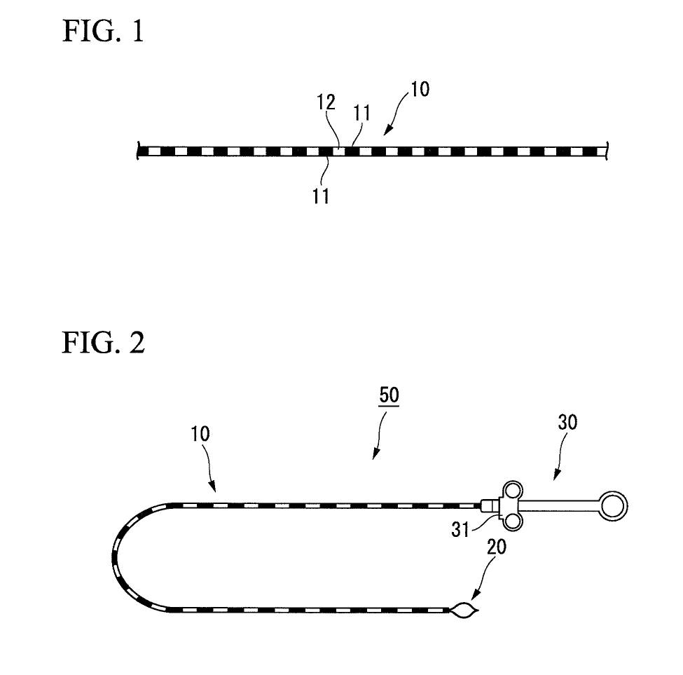

A medical tube made of the cross-linking resin composition according to this embodiment is illustrated in FIG. 1. The medical tube 10 illustrated in FIG. 1 has cross-linked regions 11 and non-cross-linked regions 12 alternately provided in the longitudinal direction. In such a medical tube, a circular tube body made of the mixture according to this embodiment is covered with belt-like shields made of materials such as lead, through which electron beams cannot be transmitted, the belt-like shields being arranged at regular intervals in the longitudinal direction of the tube body. Thereafter, the circular tube body is irradiated with electron beams to form the medical tube.

FIG. 2 illustrates an endotherapeutic device 50 using the medical tube 10 as a sheath. A manipulation portion 30 having a slider 31 is attached to a base end of the medical tube 10. A manipulation wire (not illustrated) is connected to the slider 31. A manipulation wire also extends through the medical tube 10 to a tip end side. A snare loop 20 for performing a treatment in the body is attached to the tip end portion of the manipulation wire. By advancing or retreating the slider 31 in the longitudinal direction of the manipulation portion, the snare loop 20 can protrude and retreat from the tip end of the medical tube 10.

The endotherapeutic device tool 50 has the medical tube 10 in which the flexible non-cross-linked region 12 and the cross-linked region 11 with a high elastic modulus are alternately arranged as the sheath. In this way, the cross-linked region 11 has a function of preventing the tube from collapsing and the non-cross-linked region 12 has a function of maintaining flexibility. As a result, even when an endoscope to which the endotherapeutic device 50 is inserted meanders or is bent in the body, the sheath does not easily collapse or crack and thus is preferably used.

Here, this configuration is merely an example of the cross-linking resin composition according to this embodiment. A form of the cross-linking resin composition and an arrangement form of the cross-linked region and the non-cross-linked region can be set in various ways by appropriately changing a form of the shield and a form of irradiating electron beams. As a result, various structures of cross-linking resin compositions suitable for applications and purposes can be produced.

Hereinabove, the cross-linking resin composition and the mixture according to this embodiment have been described, but the technical scope of the present invention is not limited to the above-described embodiment. Various modifications can be made in a range not departing from the scope of the present invention.

For example, in the cross-linking resin composition, an elastic modulus of the cross-linked region may be appropriately selected according to properties of a structure to be produced. Therefore, the elastic modulus of the cross-linked region may be set to be less than twice that of the non-cross-linked region by adjusting an exposure of irradiation and the like. The cross-linking resin composition according to the present invention can be preferably used when a structure having a wider range of properties than those of the related art is produced.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

What is claimed is:

1. A cross-linking resin composition containing polyethylene, polybutadiene and a Co-cross-linking agent containing a polyfunctional monomer having double bonds between carbons at two positions or more, and wherein
the polyethylene, the polybutadiene and the cross-linking auxiliary agent are mixed and formed by being molded in a predetermined form, and wherein
the cross-linking resin composition comprising:
a cross-linked region that is subjected to cross-linking reaction by ionizing radiation; and
a non-cross-linked region that is not subjected to the cross-linking reaction.

2. The cross-linking resin composition according to claim 1,
wherein an elastic modulus of the cross-linked region is more than or equal to twice that of the non-cross-linked region.

3. The cross-linking resin composition according to claim 1,
wherein the elastic modulus of the non-cross-linked region is more than or equal to 100 MPa and less than or equal to 1000 MPa.

4. The cross-linking resin composition according to claim 2,
wherein the elastic modulus of the non-cross-linked region is more than or equal to 100 MPa and less than or equal to 1000 MPa.

5. A mixture which is formed by mixing polyethylene, polybutadiene and a Co-cross-linking agent configured to contain a polyfunctional monomer having double bonds between carbons at two positions or more,
wherein an elastic modulus of the mixture after being subjected to cross-linking reaction by ionizing radiation is more than or equal to twice that before the cross-linking reaction.

6. The mixture according to claim 5,
wherein the elastic modulus before the cross-linking reaction is more than or equal to 100 MPa and less than or equal to 1000 MPa.
